(19) United States
(12) Patent Application Publication
(10) Pub. No.: US 2015/0245884 A1
(43) Pub. Date: Sep. 3, 2015

(54) MAGNETOSTRICTIVE SCALER WITH PHOSPHOR-LIGHTED INSERT AND LED-GENERATED VISIBLE LIGHT BLOCK

(71) Applicant: HU-FRIEDY MFG., LLC, Chicago, IL (US)

(72) Inventors: Marjavis J. Matthis, Chicago, IL (US); Walter V. Raczynski, Arlington Heights, IL (US); Charles L. Zimnicki, Lake Zurich, IL (US); David K. Platt, Mount Prospect, IL (US)

(21) Appl. No.: 14/430,157

(22) PCT Filed: Sep. 11, 2013
(86) PCT No.: PCT/US13/59265

§ 371 Date: Mar. 20, 2015

Related U.S. Application Data
(60) Provisional application No. 61/840,849, filed on Jun. 28, 2013.
(60) Provisional application No. 61/705,437, filed on Sep. 25, 2012.

(51) Int. Cl. A61C 1/08; A61C 17/00; A61C 17/02; F21V 9/16

(52) U.S. Cl. CPC A61C 1/088; F21V 9/16; A61C 17/005; A61C 17/0202; F21W 2131/202

(57) ABSTRACT

This disclosure relates generally to lighted dental instruments and, more particularly, to powered dental scalers incorporating both an integral light source and a fluid passageway that directs fluid adjacent to tooth surfaces with which the scalers are in contact.

This application claims priority to U.S. Application Ser. No. 61/705,437, entitled “POWERED SCALER WITH LIGHTED BACTERIA-REDUCING INSERT” and filed Sep. 25, 2012, the entire disclosure of which is hereby incorporated by reference herein. Additionally, this application claims priority to U.S. Application Ser. No. 61/840,849, entitled “MAGNETOSTRICTIVE SCALER WITH PHOSPHOR-LIGHTED INSERT AND LED-GENERATED VISIBLE LIGHT BLOCK” and filed Jun. 28, 2013, the entire disclosure of which is hereby incorporated by reference herein.

### FIELD OF THE DISCLOSURE

This disclosure relates generally to lighted dental instruments and, more particularly, to powered dental scalers incorporating both an integral light source and a fluid passageway that directs fluid adjacent to tooth surfaces with which the scalers are in contact.

### BACKGROUND

Lighted dental scaler systems have been developed and marketed. Some of these existing systems rely on electromagnetic induction, by which current from a first coil, which induces vibration in a magnetostrictive stack, also induces a current flow in a second coil. The induced current in the second coil causes a visible light source, in the form of an electrically-powered bulb, to illuminate.

Other conventional lighted dental scaler systems rely on vibration of the scaler tip to induce an electric current in a second coil (i.e., as opposed to relying directly on magnetic fields induced by electrical current in a first coil that induces vibrations in the magnetostrictive stack). The electric current in the second coil is then used to power the visible light source.

Both of these systems depend upon the alternating current in the first coil to power the visible light source. This dependence leads to a number of drawbacks, such as the problem of fluctuations in power levels, which may be desirable to alter the intensity of vibration of the scaler tip, resulting in fluctuations in brightness of the visible light source. Another drawback is that when power to the scaler tip is turned off, the visible light source will no longer illuminate.

Another lighted dental scaler system has been proposed that utilizes an independent battery to power the visible light source. Such a system advantageously overcomes problems of intensity variation and illumination when power is not being supplied to the scaler, but providing a separate power source in the form of a battery raises costs and can render sterilization of the system more complicated as compared to other lighted dental scaler systems.

### SUMMARY

A lighted dental scaler system employs energy from one or more electromagnetic energy sources operating in the visible or non-visible light spectrum, referred to herein as “energy sources.” For example, the one or more energy sources may be a set or array of light-emitting diodes (LEDs) that generates blue light, white light, infrared (IR) radiation, or ultraviolet (UV) radiation. The energy is transmitted from the energy source through an energy conductive medium to a lens that is coated with phosphor material. Alternatively or additionally, phosphor material is embedded into material from which the lens is made. As such, the lens is referred to herein as a “phosphor lens,” which generally refers to both phosphor-coated and phosphor-embedded lenses. The phosphor material of the lens is excited or activated upon exposure to the energy generated by the energy sources which, in turn, causes the phosphor material to emit visible light (i.e., glow). The visible light emitted by the phosphor material may be directed or focused to illuminate the area around the scaler tip or to illuminate the oral cavity. For example, the lens may be of a cone shape having a concave surface coated with phosphor so that light generated by the phosphor material is focused by the cone, but the phosphor coating is protected from wearing away. Powered dental scaler systems of the present disclosure also may include a fluid passageway that directs fluid adjacent to tooth surfaces with which the scalers are in contact.

In an embodiment, the energy conductive medium (or “energy conductor”) through which the energy generated by the energy source is conducted to reach and activate the phosphor lens is a light pipe. For example, a handpiece or an insert of a dental scaler may include one or more energy sources that generate visible light having wavelengths in the visible spectrum, e.g., between 400 nm and 700 nm. The visible light generated by the energy sources may be conducted through the light pipe to activate the phosphor lens.

In an embodiment, the energy conductive medium or energy conductor through which the energy generated by the energy source is conducted to reach and activate the phosphor lens is a set of filters, e.g., a set of one or more filters. The set of filters may block the passage of electromagnetic energy in the visible spectrum (e.g., visible light) while allowing the passage of electromagnetic energy in the non-visible spectrum to activate the phosphor lens. For example, a handpiece or an insert of a dental scaler includes one or more energy sources that generate electromagnetic energy in the non-visible spectrum. In an embodiment, the energy source or sources generate energy having a wavelength in the UV spectrum, e.g., between 200 nm and 400 nm. Non-visible UV energy within this wavelength range is found to be sufficient to activate the phosphor material of a lens to generate visible light.

In this embodiment, the non-visible electromagnetic energy is conducted through the set of filters. The set of filters blocks any visible light which may have been incidentally generated by the non-visible energy sources. For example, if the energy sources are UV energy sources, the set of filters blocks electromagnetic energy at the high end of the wavelength emission curve of the UV energy sources. As such, only non-visible electromagnetic energy is allowed to pass through the set of filters to excite the phosphor material.

By filtering out any visible light which may have been incidentally generated by the non-visible electromagnetic energy sources, the actual visible light produced and emitted by the lighted dental scaler system or instrument is wholly generated by the activation of the phosphor material. Consequently, the intensity and focus of all visible light produced by the lighted dental scaler system or instrument may be easily known and controlled. This control of generated visible light in dental instruments is important, especially in dental applications where the diffusion of uncontrolled visible light may inadvertently cause the curing of a dental compound, or may cause other undesired effects during a dental procedure.

In an embodiment, the set of filters that block visible light are disposed in between non-visible electromagnetic energy sources and the phosphor material. For example, one edge surface of the set of filters abuts or is disposed directly adjacent to the energy sources. Additionally or alternatively, an opposite edge surface of the set of filters may abut or be disposed directly adjacent to the phosphor material.

In one embodiment of the present disclosure, a handpiece of the lighted dental scalar system includes one or more energy sources, an energy conductor, a primary coil, and a driving circuit that causes an essentially constant voltage to be conducted to the one or more energy sources. The handpiece may selectively receive a modular scaler insert portion, which includes (in the case of a magnetostrictive dental scaler) a stack of nickel leafs, a metal connecting body having an irrigating fluid channel therein, and a scaler tip, as well as one or more filters and a phosphor lens. When the scaler insert is engaged in the handpiece and an alternating current (AC) is applied to the primary coil of the handpiece, an alternating magnetic field is generated by the primary coil, which causes the stack of nickel leafs to vibrate, and consequently, the scaler tip to move. The driving circuit of the handpiece also receives the alternating current, and converts the alternating current into a steady or constant voltage to power the energy source. In an embodiment, the driving circuit is a voltage regulator that may be tuned to control the intensity of the energy emitted by the energy source.

In an example configuration, the energy source generates visible light, and the energy conductor is a light pipe. In an alternate example configuration, the energy source generates non-visible electromagnetic energy (e.g., UV light), and the energy conductor is a set of filters configured to block visible light while allowing the passage of the non-visible electromagnetic energy.

In an alternate embodiment, the handpiece includes a primary coil. The one or more energy sources, the energy conductor, the phosphor lens, the driving circuit for the one or more energy sources, and a secondary coil are provided as a modular insert component of the lighted dental insert system that can be selectively received within the handpiece. The modular insert component can advantageously be appropriately dimensioned so as to be received within a conventional handpiece. When the scaler insert is engaged in the handpiece and an alternating current is applied to the primary coil, an alternating magnetic field is generated by the primary coil which causes the stack of nickel leafs to vibrate, and consequently, the scaler tip to move. The secondary coil included in the insert is inductively coupled to the primary coil, and thus the secondary coil generates an alternating current corresponding to the alternating magnetic field generated by the primary coil. The driving circuit of the insert receives the alternating current generated by the secondary coil, and converts the generated alternating current into a steady or constant voltage to power the energy source. In an embodiment, the driving circuit is a voltage regulator that may be tuned to control the intensity of the energy source. Thus, in this alternate embodiment, the light generation means for the scaler system is entirely included in an autoclavable modular insert, which may be compatibly used with various different types of dental scaler handpieces. Further, in this alternate embodiment, the energy sources generates non-visible electromagnetic energy, and the energy conductor may comprise one or more filters that block visible light while allowing non-visible electromagnetic energy to be conducted to reach the phosphor lens.

In another aspect of the present disclosure, the phosphor lens may be in the form of a coated conical member that is selectively engageable with the scaler tip, the one or more filters, or with a portion of the insert that supports the scaler tip and/or the one or more filters. The coated conical member may have variations in the types of phosphor material coated thereon, such that depending on an adjustable orientation of the coated cone member, the activated phosphor coating exhibits different characteristics. For instance, the coated cone member of a lighted dental scaler system of the present disclosure may be variably coated in such a manner that, when installed on the scaler tip in a first orientation relative to the orientation of the tip and exposed to UV energy from a UV energy source, the phosphor material of the coated conical member generates visible white light, which is useful to a dental practitioner to illuminate the oral cavity of a patient for increased visibility, and when rotated to a second orientation relative to the orientation of the tip and exposed to UV energy from the UV energy source, the phosphor material generates fluorescent light, such as black light, which is useful for diagnostic purposes in identifying food deposits, plaque, or tartar on the patient's teeth.

In an embodiment, the one or more filters may be selectively engageable with the insert or with a portion of the insert that supports the scaler tip and/or the phosphor lens.

### BRIEF DESCRIPTION OF THE SEVERAL VIEWS OF THE DRAWING

FIG. 1 is a semi-schematic view of a first embodiment of a lighted dental scaler system of the present disclosure;

FIG. 2 is a front perspective view of the lighted dental scaler system of FIG. 1;

FIG. 3 is a front perspective view of the lighted dental scaler system of FIG. 2, illustrating the scaler insert partially withdrawn from the handpiece thereof;

FIG. 4 is an enlarged, longitudinally cross-sectional view of a portion of the lighted dental scalar system of FIG. 1;

FIG. 5 is a enlarged, bottom plan view of a portion of the lighted dental scalar system of FIG. 1;

FIG. 6 is an enlarged bottom perspective view of a portion of the lighted dental scalar system of FIG. 1;

FIG. 7 is a semi-schematic view of a second embodiment of a lighted dental scaler system of the present disclosure;

FIG. 8 is a top perspective view of a modular insert component of the lighted dental scaler system of FIG. 7;

FIG. 9 is a side plan view of a modular insert component of the lighted dental scaler system of FIG. 7 illustrated in cross-section;

FIG. 10 is a perspective view of a phosphor lens which may be used with the lighted dental scaler system of FIG. 7;

FIG. 11 is an exploded perspective view of the modular insert component of the lighted dental scaler system of FIG. 7, with the scaler tip and hermetic seal omitted from the illustration;

FIG. 12 is a perspective view of a modular insert component of the lighted dental scaler system of FIG. 7, with the scaler tip and hermetic seal included in the illustration;

FIG. 13 is a front plan view of a modular insert component of the lighted dental scaler system of FIG. 7, with portions of the modular insert component illustrated in cross-section;

FIG. 14 is a top plan view of a scaler tip and integral connecting body of FIG. 7;

FIG. 15 is a perspective view illustrating the insertion of a phosphor-coated cone on a scaler tip of a lighted dental scaler system of the present disclosure;

FIG. 16 is a front perspective view of the lighted dental scaler system of FIG. 15, illustrating an ability to rotate the phosphor-coated cone relative to an orientation of the scaling tip of the lighted dental scaler system;

FIG. 17 is a front perspective view of the lighted dental scaler system of FIGS. 15 and 16, wherein the phosphor-coated cone is arranged to emit, upon excitation by UV energy, visible white light;

FIG. 18 is a front perspective view of the lighted scaler system of FIGS. 15 and 16, illustrating rotation of the phosphor-coated cone thereof from a first position, as illustrated in FIG. 17, to a second position; and

FIG. 19 is a front perspective view of the lighted dental scaler system of FIGS. 15 and 16, wherein the phosphor-coated cone is arranged to emit, upon excitation by UV energy, fluorescent light, such as UV black light, that is useful in a diagnostic mode to facilitate identification of plaque, tartar, food deposits, or fluorescent light-activated mouthwash.

### DETAILED DESCRIPTION OF THE PREFERRED EMBODIMENTS

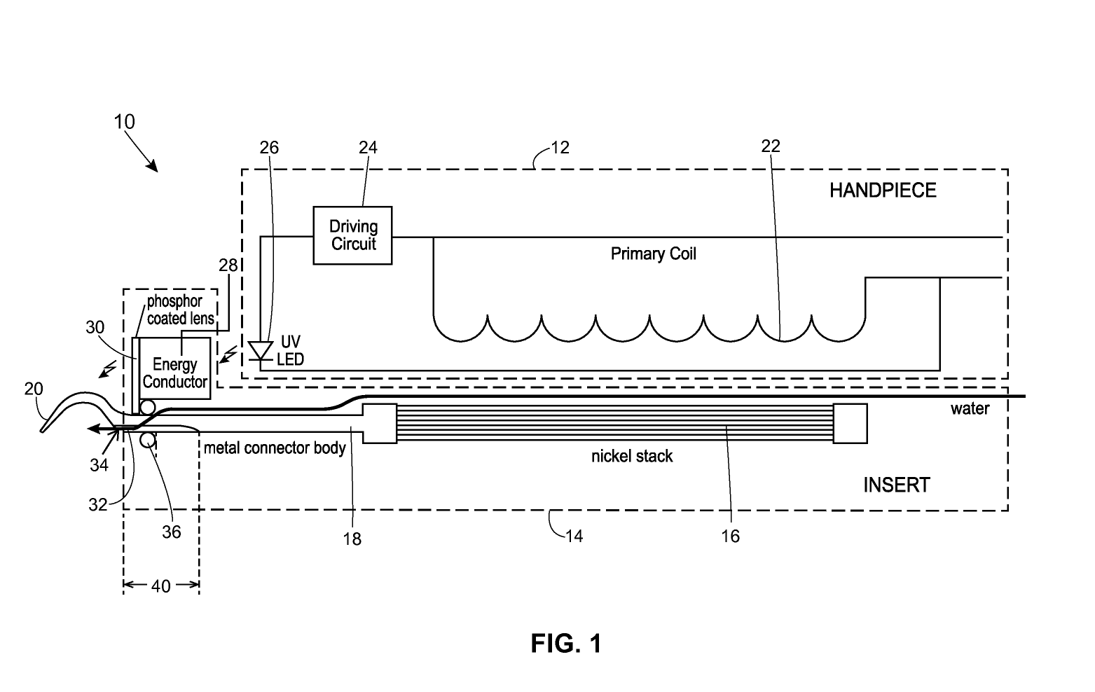

With reference to the drawing figures, as illustrated in FIGS. 1-3, a lighted dental scaler system 10 of a first embodiment of the present disclosure includes a handpiece 12 and an insert 14 with a stack 16 of nickel leafs, a connecting body 18, and a scaler tip 20. The insert 14 is selectively received in the handpiece 12, and when so received in the handpiece, a primary coil 22 provided in the handpiece 12 is disposed about the nickel stack 16. When alternating current (AC) is applied to the primary coil 22, a corresponding alternating magnetic field is generated. The alternating magnetic field causes the stack 16 to vibrate, which in turn causes transmission of vibration through the connecting body 18, ultimately resulting in desired rapid vibration of the scaler tip 20, which movement facilitates the removal of calculus from tooth enamel.

The lighted dental scaler system 10 further includes a light assembly having a driving circuit 24 that receives alternating current from the primary coil 22, converts the alternating current to a direct current at a steady voltage or constant voltage, and provides the direct current to an energy source 26. The energy source 26 may include a set of one or more devices that receive power and consequently generate electromagnetic energy. The one or more devices included in the energy source 26 may be arranged in any configuration, such as linearly, in a ring or other two-dimensional shape, or some other suitable configuration. For instance, the energy source 26 may comprise an array of two or more LEDs. As used herein, the term “array” includes both linear and non-linear arrangements of two or more objects, and the plurality of objects within the array may or may not be evenly spaced from one another. The driving circuit 24 preferably includes a voltage regulator that may be tuned to control the brightness or intensity of the energy source 26.

The energy source 26 may emit energy in the visible light spectrum (e.g., in an electromagnetic wavelength range from about 400 nm to about 700 nm), in the near-infrared (IR) spectrum (e.g., in an electromagnetic wavelength range from about 700 nm to about 2,200 nm) or in the ultraviolet (UV) spectrum (e.g., in an electromagnetic wavelength range from about 200 nm to about 400 nm). In some embodiments, different devices included in the energy source 26 may emit different ranges of wavelengths, e.g., one device may emit blue light while another device emits UV light. In an embodiment, at least one of the devices included in the energy source 26 generates electromagnetic energy in the non-visible UV range of 200 nm to 400 nm. UV energy within this range is found to be sufficient to activate phosphor material to generate visible light.

The energy source 26, when activated by current conducted by the driving circuit 24, emits energy that is received at the phosphor lens 30. In an embodiment, the energy source 26 emits energy that is conducted through an energy conductor 28. In the embodiment of the system 10 illustrated in FIG. 1, the energy conductor 28 is a light pipe 28 included in the insert 14, and the energy source 25 generates visible electromagnetic energy or light.

In some cases, more stringent control over the emission and diffusion of visible light may be desired, such as when curable dental compounds are being used within the vicinity of the scaler system 10. For these cases, in an embodiment of the system 10 (not shown), the energy source 26 is configured to emit non-visible electromagnetic energy, such as UV energy, and the phosphor lens 30 is the primary or sole source of visible light emitted from the system 10. In this embodiment, instead of the energy conductor 28 being a light pipe, the energy conductor 28 comprises one or more filters. The one or more filters may be configured to block visible light. For example, when the insert 14 is engaged in the handpiece 12, the energy source 26 may abut or may be disposed directly adjacent to a first side edge of the one or more filters without any light pipe, energy pipe, or other physical, conductive, electromagnetic transmission medium disposed therebetween. Additionally or alternatively, an opposite side edge of the one or more filters may abut or may be disposed directly adjacent to the phosphor lens 30. In this embodiment, the one or more filters block any incidentally generated visible light emitted by the energy source 26 from reaching the phosphor lens 30, e.g., only non-visible electromagnetic energy reaches the phosphor lens 30.

Upon exposure to the electromagnetic energy generated by the energy source 26, the phosphor material of the lens 30 is activated. In an embodiment, the phosphor material coats the lens 30. Alternately or additionally, the phosphor material is embedded in the material from which the lens 30 is made.

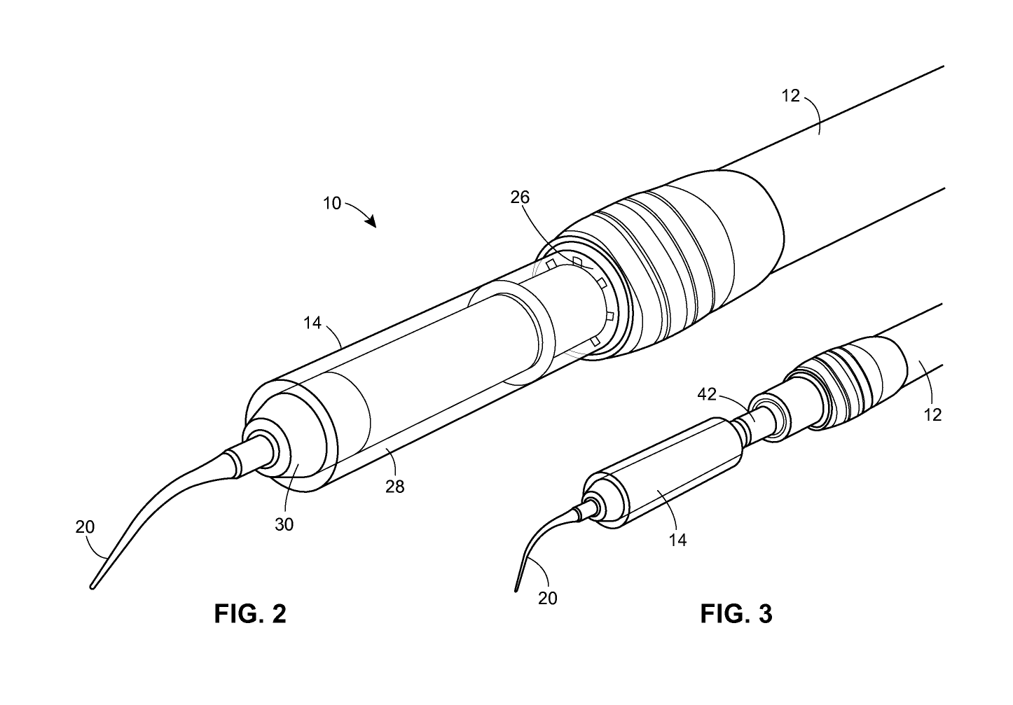

Depending on the characteristics of the phosphor material of the lens 30, upon activation, the phosphor material emits visible electromagnetic energy, e.g., a visible white light. Additionally or alternatively, the phosphor material generates fluorescent light. In some embodiments, more than one type of phosphor material is used with the lens 30 so that light of multiple different wavelength ranges is generated (e.g., both white light and fluorescent light). As illustrated in FIG. 2, the phosphor lens 30 may be in the form of a conical member 30. In other embodiments, a separate focusing component (not shown) may be removably attached to the insert 14 to focus the light emitted by the phosphor lens 30 in a desired direction.

The connecting body 18 includes an irrigating fluid flow channel 32. The fluid flow channel 32 has an outlet port 34 that permits liquid (e.g., water) to spray onto a tooth surface in the vicinity of the scaler tip 20 for the purpose of cooling the tooth and the scaler tip 20. As illustrated in FIG. 1, a gasket 36, such as a o-ring, is disposed about the connecting body 18 at an intersection of the light pipe 28 and the phosphor lens 30.

In the embodiment shown in FIGS. 1-3, the irrigation fluid flow channel 32 is disposed on an external surface of the connecting body 18. In an embodiment, a portion of an exterior surface of the connecting body 18 may be longitudinally chamfered to form an external portion 40 of the irrigation fluid flow channel 32. The remainder internal portion of the irrigation fluid flow channel 32 is entirely surrounded the connecting body 18 and is not visible in FIGS. 1-3. However, for clarity, FIG. 3 illustrates a fluid inlet port 42 disposed at the end of the irrigation fluid flow channel 32 that is distal from the scaler tip 20. At the inlet port 42, fluid may be delivered into the channel 32 for passage through the internal portion of the channel 32 and the external portion 40 of the channel to the fluid outlet port 34 proximate to the scaler tip 20.

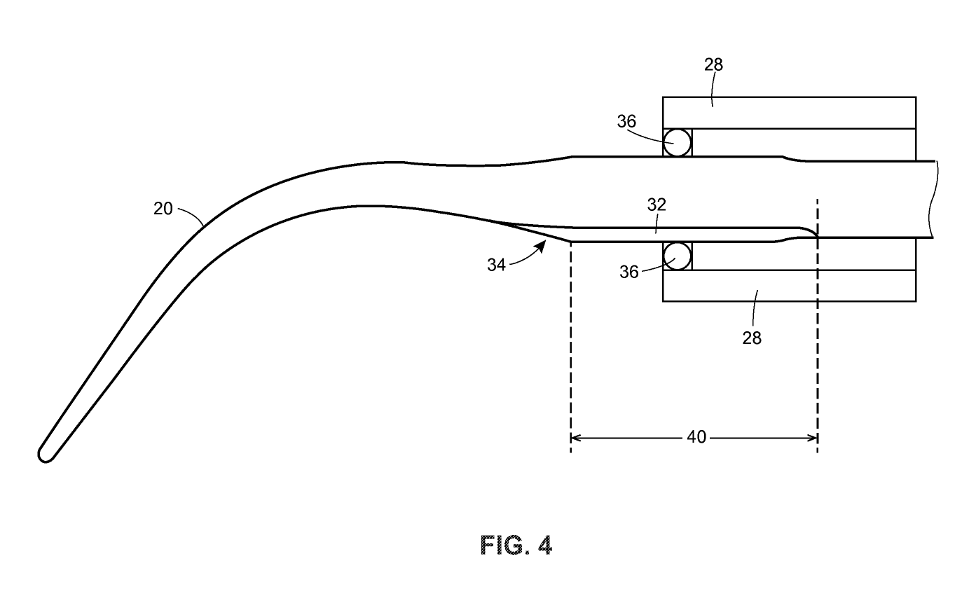

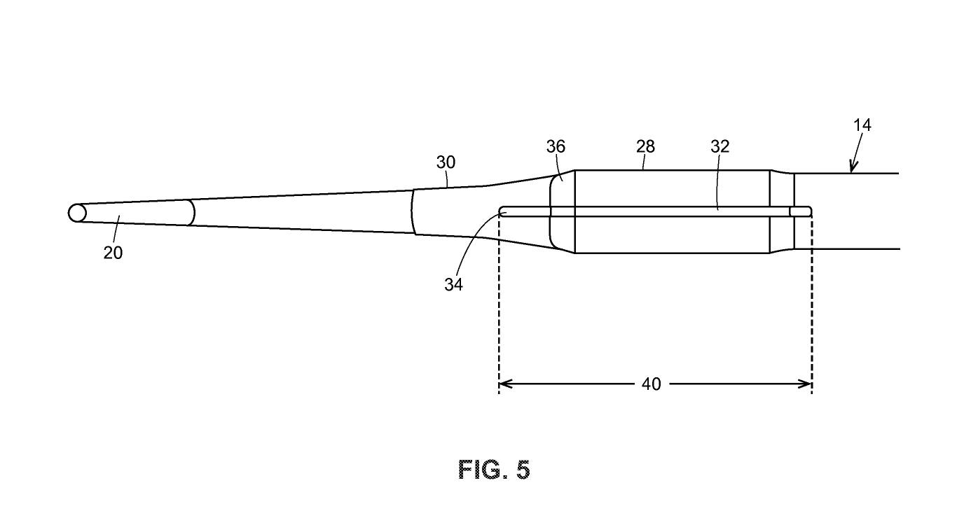

FIGS. 4-6 illustrate the arrangement of the tip 20, the energy conductor 28, and the external portion 40 of the irrigation fluid flow channel 32 included in FIGS. 1-3. The fluid inlet port 42 is visible in FIG. 6.

Although FIGS. 1-6 depict the exterior portion 40 of the irrigation fluid flow channel 32 as a single chamfer, the external portion 40 of the irrigation fluid flow channel 32 may be configured with any number, pattern, size, and/or cross-sectional shape of chamfers. For example, the connecting body 18 may include multiple, parallel chamfers originating at and branching out from the junction between the internal and external 40 portions of the irrigation fluid flow channel 32. In some embodiments, at least two chamfers may have different cross-sectional shapes and/or may have different radial depths.

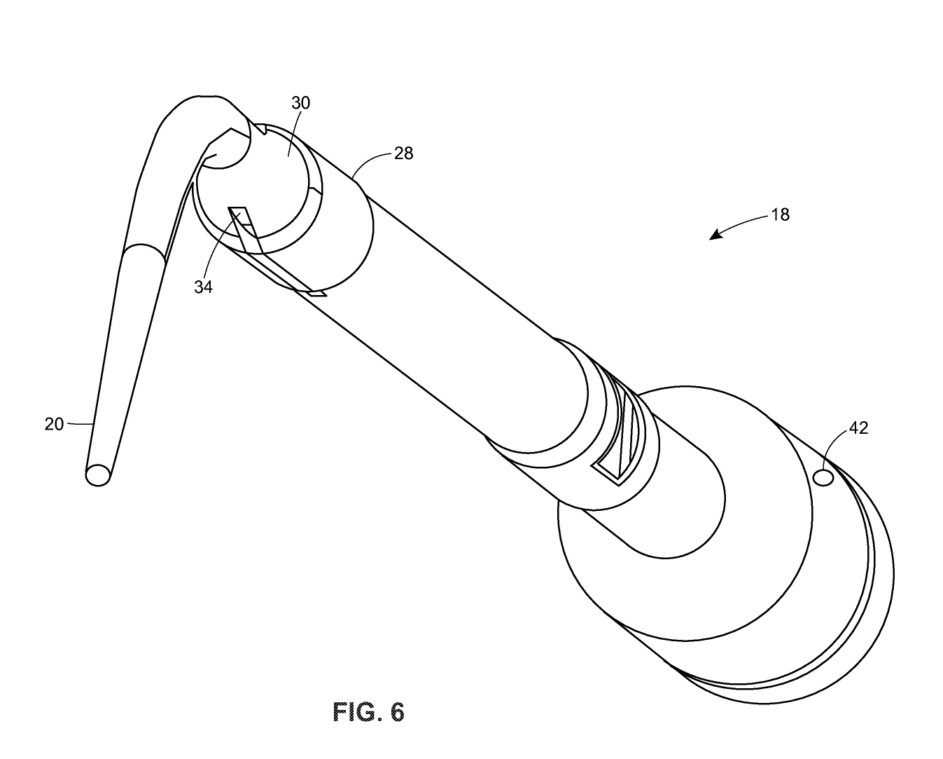

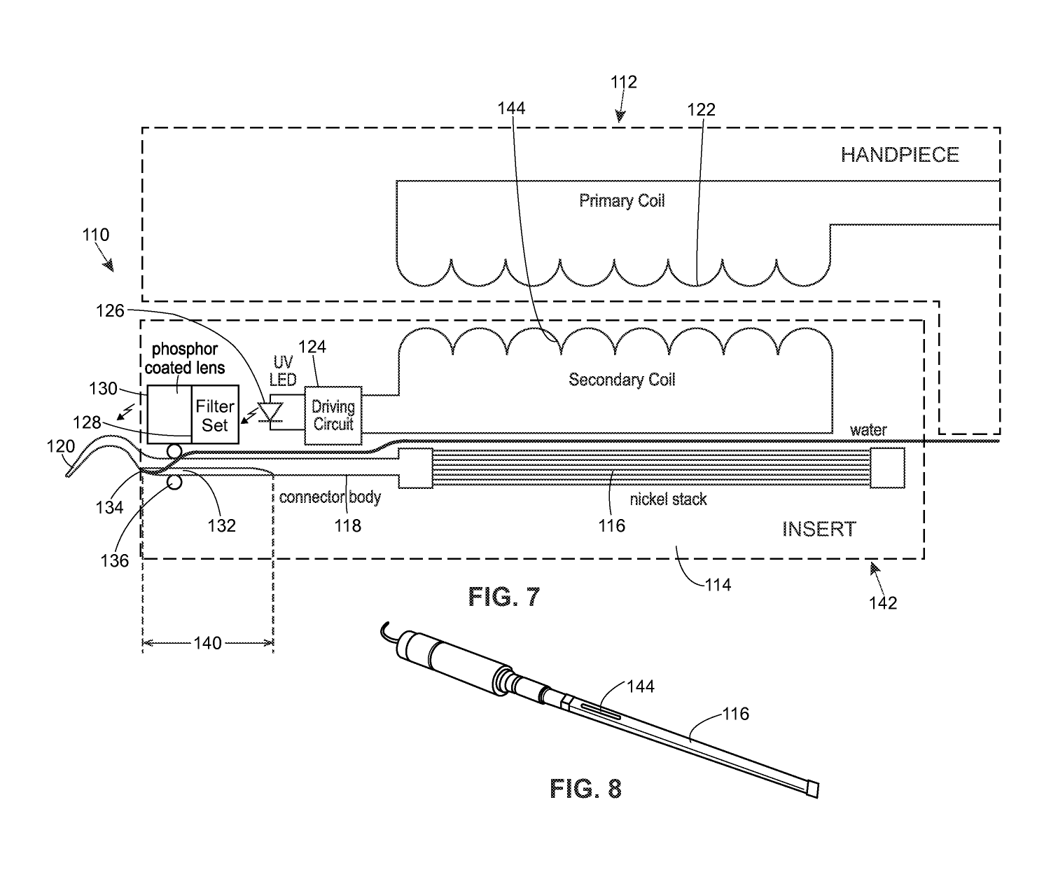

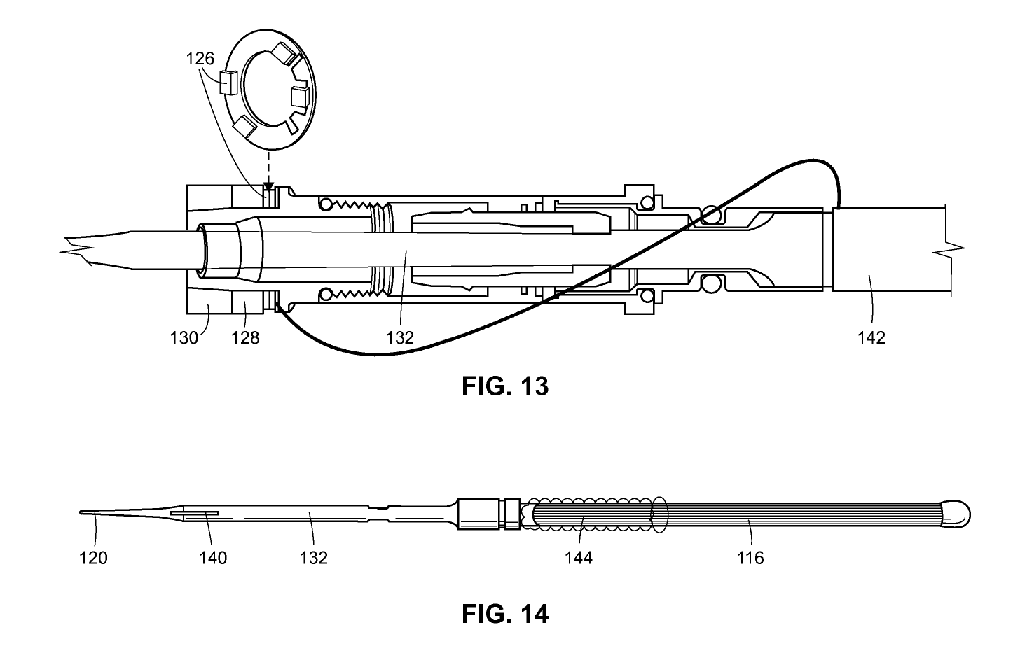

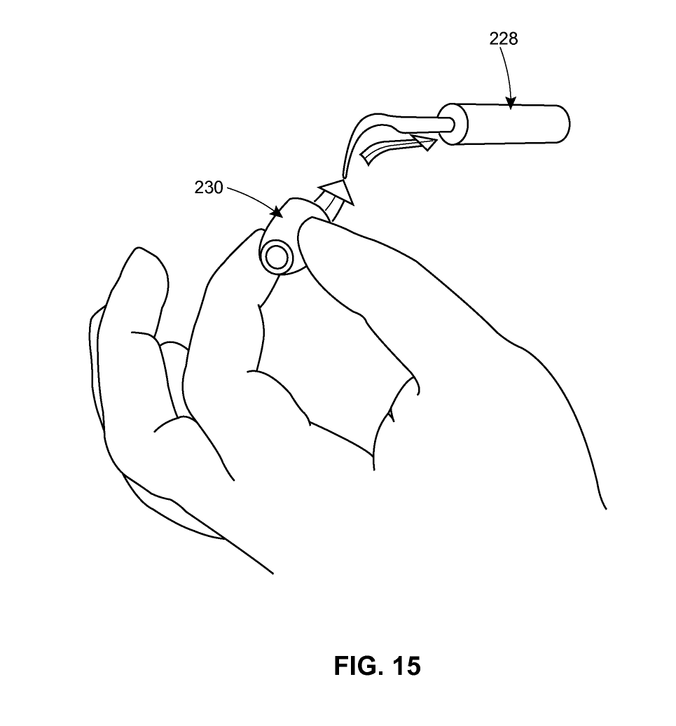

Turning to FIGS. 7-14, an alternate embodiment of a lighted dental scaler system 110 of the present disclosure is illustrated. According to this embodiment, a scaler insert 114, an energy source 126, one or more filters 128, a phosphor lens 130, a gasket 136 (such as an o-ring), and a driving circuit 124 for the energy source 126 are all provided as a modular insert component 142 of the lighted dental insert system 110. The modular insert component 142 can be selectively received within a handpiece 112 that includes a primary coil 122. In this alternate embodiment, the energy source 126 generates non-visible electromagnetic energy, such as UV energy, and may be similar to the embodiment of the non-visible energy source 26 previously discussed with respect to FIGS. 1-3. Similarly, the one or more filters 128 and the phosphor lens 130 may be respectively similar to the embodiment of FIGS. 1-3 having the set of filters and phosphor lens 30, as previously discussed.

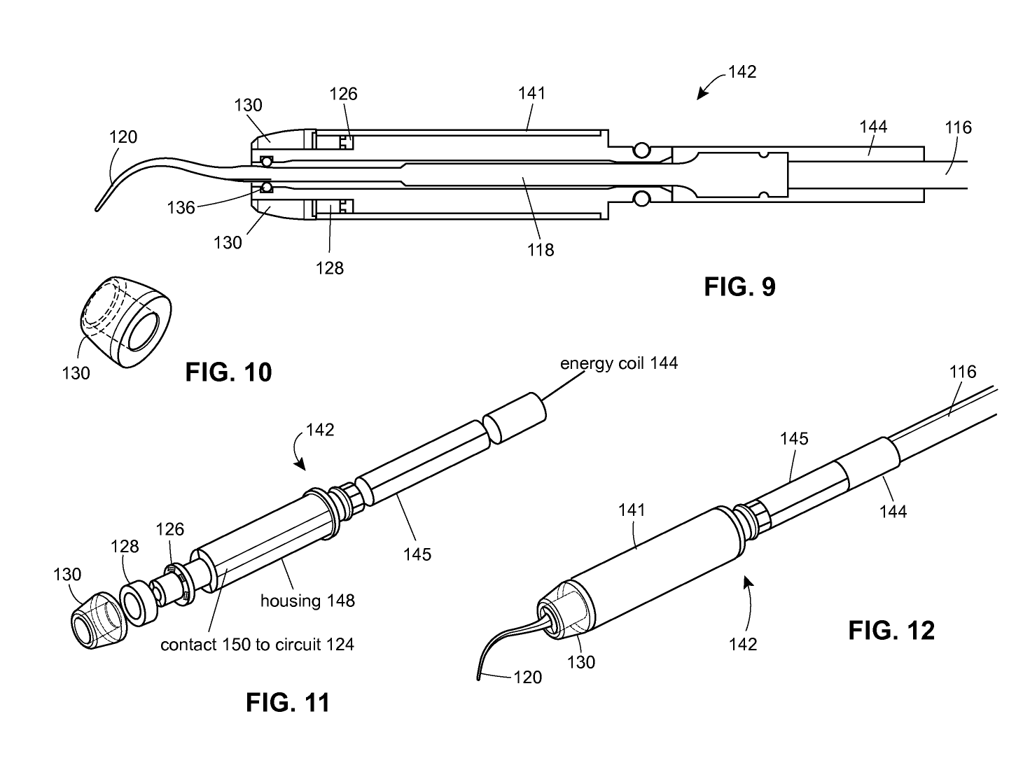

As shown in FIG. 9, the energy source 126 and the filter 128 are enclosed by a hermetic seal 141 that abuts the phosphor lens 130. The hermetic seal 141 may further aid in preventing any undesired incidental visible light from being diffused into the environs of the dental scaler system 110, and may ensure that only filtered, non-visible electromagnetic energy generated by the energy source 126 reaches the phosphor lens 130. Additionally, the hermetic seal 141 may add to the ability of the modular insert component 142 to be autoclavable.

The scaler insert 114 includes a nickel stack 116, a connecting body 118, and a scaler tip 120. In this alternate embodiment, a secondary coil 144 is provided as part of the modular insert component 142. The secondary coil 144 is a harvesting coil that does not extend axially along the full length of the nickel stack 116, but rather, as illustrated in FIG. 8, only extends a short axial distance along the stack 116. In an embodiment, the secondary coil 144 is wound around or otherwise supported by a bobbin 145 that is, in turn, supported by the connecting body 132. In an embodiment, the bobbin 145 and the connecting body 132 are an integral unit.

When the modular insert component 142 is engaged in the handpiece 112 and an alternating current (AC) is applied to the primary coil 122 of the handpiece 112, an alternating magnetic field is generated by the primary coil 122, which causes the stack of nickel leafs 116 to vibrate and consequently, upon transmission of the vibration through the connecting body 118, the scaler tip 120 moves. The secondary coil 144 is inductively coupled to the primary coil 122, and as such, the secondary coil 144 generates a secondary alternating current based on the alternating current flowing through the primary coil 122. The secondary alternating current is provided to the driving circuit 124, which converts the secondary AC into a direct current at a steady or constant voltage to power the energy source 126. In an embodiment, the driving circuit 124 is a voltage regulator that may be tuned to control the brightness of the energy source 126. In the lighted dental scaler system 110, the non-visible energy emitted by the energy source 126 may be conducted through and filtered by the energy conductor 128 so that only non-visible electromagnetic energy excites the phosphor lens 130, in a manner similar to that previously discussed with respect to the previous embodiment 10.

FIG. 11 is an exploded view of the modular insert component 142, with at least the tip 120, the connecting body 118, and the hermetic seal 141 omitted for illustrative purposes only. As shown in FIG. 11, a housing 148, such as a resin housing, supports an electrical contact 150. The electrical contact 150 delivers current generated by the secondary coil 144 to the driving circuit 124 (which is not visible in FIG. 11), so that the driving circuit 124 powers the energy source 126.

FIG. 12 is a perspective view of the modular insert component 142. FIG. 12 illustrates the hermetic seal 141 surrounding at least the resin housing 148, the driving circuit 124, the energy source 126, and the visual light filter 128, and thus obscuring these elements from view in the illustration.

Additionally, as discussed with respect to the previous embodiment 10, in this alternate embodiment 110 the connecting body 118 includes an irrigating fluid flow channel 132. The arrangement of the tip 120, the one or more filters 128, and the external portion 140 of the irrigation fluid flow channel 132 may be similar to the arrangement shown in FIGS. 4-6.

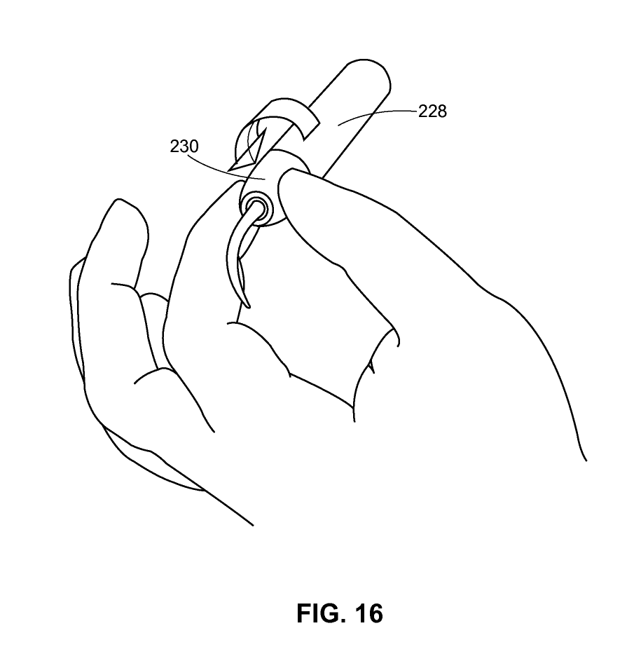

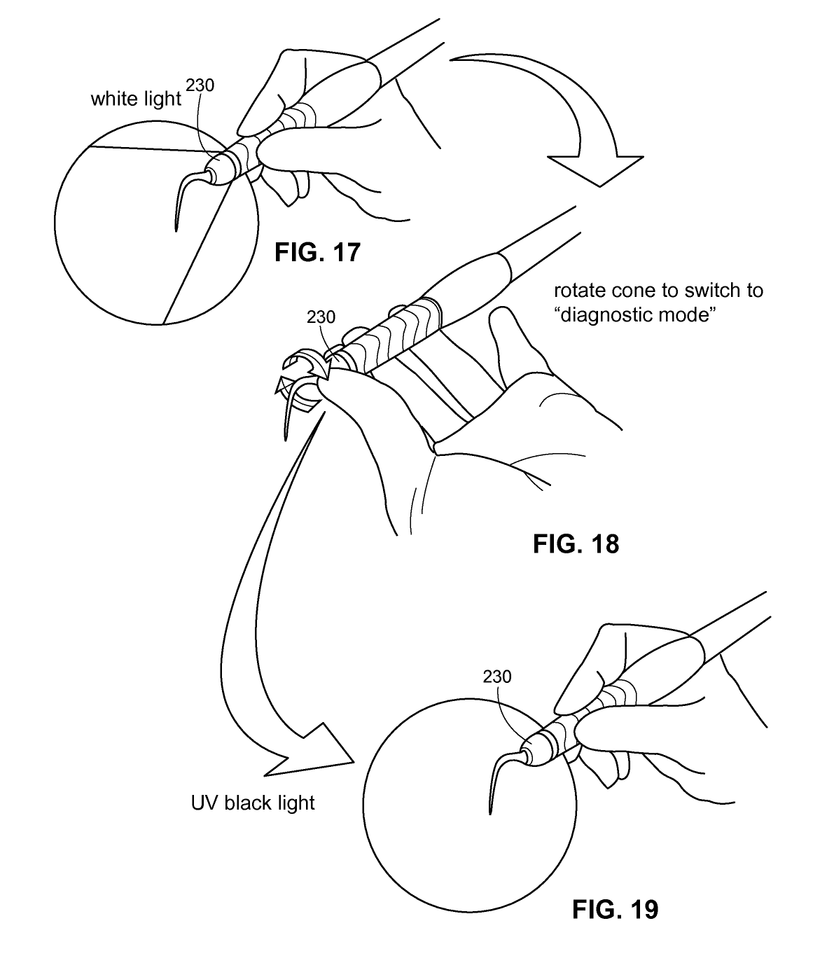

With respect to FIGS. 15-19, a particular phosphor-coated lens 230 is illustrated that could be used with either of the above-described embodiments of a lighted dental scaler system of the present disclosure. The phosphor-coated lens 230 includes a first portion coated with a first phosphor material that, when the phosphor-coated lens 230 is in a first orientation relative to a UV energy conductor 228, upon exposure to UV energy from the UV energy conductor 228, the phosphor-coated lens 230 emits visible white light, as illustrated in FIG. 17. A second portion of the phosphor-coated lens 230 is coated with a second phosphor material that, when the phosphor-coated lens 230 is in a second orientation relative to the UV energy conductor 228, upon exposure to UV energy from the UV energy conductor 228, the phosphor-coated lens 230 emits a fluorescent light, such as UV black light, as illustrated in FIG. 19. This fluorescent light may be useful in a diagnostic mode of the lighted dental scaler system of the present disclosure, as the fluorescent light intensifies contrast between tooth enamel and plaque, tarter, food particles, or other foreign objects to be removed during a dental procedure.

While various embodiments have been described above, it will be appreciated that variations may be made thereto that are still within the scope of the appended claims.

What is claimed is:

1. A lighted dental scaler system comprising:
an energy source;
a lens having at least one of a phosphor coating or embedded phosphor material;
a energy conductor disposed intermediate the energy source and the lens; and
a driving circuit in one of electrical or inductive communication with a primary coil, the driving circuit delivering a constant voltage to the energy source.

2. The lighted dental scaler system of claim 1, wherein the primary coil receives an alternating current that induces an alternating magnetic field to impart vibration to a nickel stack of an insert received in a handpiece of the lighted dental scaler system.

3. The lighted dental scaler system of claim 1, wherein the energy source includes one or more devices that emit electromagnetic energy.

4. The lighted dental scaler system of claim 3, wherein at least a subset of the one or more devices that emit electromagnetic energy emits electromagnetic energy in the ultraviolet spectrum.

5. The lighted dental scaler system of claim 1, wherein the energy source includes an array of light-emitting diodes (LEDs).

6. The lighted dental scaler system of claim 1, wherein the lens includes a conical lens received on a tip of the lighted dental scaler system.

7. The lighted dental scaler system of claim 1, further including a scaler tip provided on a connecting body, and the connecting body includes an irrigation fluid channel therein.

8. The lighted dental scaler system of claim 1, wherein the energy conductor is a light pipe.

9. The lighted dental scaler system of claim 1, wherein the energy conductor is a set of filters configured to block visible light.

10. The lighted dental scaler system of claim 9, wherein the energy source generates energy in the ultraviolet electromagnetic spectrum.

11. The lighted dental scaler system of claim 1, wherein the lens includes
a first portion coated with a first phosphor material that, when the lens is in a first orientation relative to the energy conductor, upon exposure to energy from the energy conductor, the phosphor-coated lens emits visible white light generated from excitation of the first phosphor material; and
a second portion coated with a second phosphor material that, when the lens is in a second orientation relative to the energy conductor, upon exposure to energy from the energy conductor, the phosphor-coated lens emits a fluorescent light generated from excitation of the second phosphor material.

12. The lighted dental device of claim 1, wherein the energy source and the driving circuit are disposed in a handpiece of the lighted dental scaler system.

13. The lighted dental device of claim 12, wherein the energy conductor, the lens, and a scaling tip are supported by an insert that is selectively receivable by the handpiece.

14. The lighted dental device of claim 1, wherein the energy source, the driving circuit, the energy conductor, the lens, and a scaling tip are disposed in an insert of the lighted dental scaler system, the insert being selectively receivable by a handpiece of the lighted dental scaler system.

15. A method of providing light at a tip of dental scaler system, comprising:
converting an alternating current to a direct current at a constant voltage;
generating non-visible electromagnetic energy using the direct current at the constant voltage;
exciting, using the non-visible electromagnetic energy, phosphor material to generate visible light;
delivering the visible light to be emitted proximate to the tip of the dental scaler system.

16. The method of claim 10, further comprising delivering, using an energy conductive medium, the non-visible electromagnetic energy to excite the phosphor material.

17. The method of claim 16, further comprising:
generating visible electromagnetic energy in conjunction with the non-visible electromagnetic energy using the direct current at the constant voltage; and
blocking, using the energy conductive medium, the visible electromagnetic energy from exciting the phosphor material.

18. The method of claim 17, wherein the visible electromagnetic energy has a wavelength of 400 nm or greater.

19. The method of claim 15, wherein the non-visible electromagnetic energy has a wavelength less than 400 nm.

20. The method of claim 15, further comprising delivering the fluid into the oral cavity using a connector body disposed between the tip and a vibrating stack included in an insert of the lighted dental scaler system.

21. The method of claim 15, wherein at least one of:
converting the alternating current to the direct current at the constant voltage comprises converting the alternating current to the direct current at the constant voltage at a handpiece of the lighted dental scaler system; or
converting the alternating current to the direct current at the constant voltage comprises converting the alternating current to the direct current at the constant voltage at an insert of the lighted dental scaler system.

22. The method of claim 15, further comprising causing the tip of the lighted dental scaler system to move in conjunction with the alternating current.
